(19) United States
(12) Patent Application Publication
(10) Pub. No.: US 2025/0384125 A1
(43) Pub. Date: Dec. 18, 2025

(54) SECURE SYSTEM AUTOMATED DESIGN DEVICE, SECURE SYSTEM AUTOMATED DESIGN METHOD, AND STORAGE MEDIUM

(71) Applicant: NEC Corporation, Tokyo (JP)

(72) Inventor: Ryosuke Hotchi, Tokyo (JP)

(73) Assignee: NEC Corporation, Tokyo (JP)

(21) Appl. No.: 19/223,405

(22) Filed: May 30, 2025

(30) Foreign Application Priority Data
Jun. 14, 2024 (JP) 2024-096889

(51) Int. Cl. G06F 21/55

(52) U.S. Cl. CPC G06F 21/552; G06F 2221/034

(57) ABSTRACT

A secure system automated design device accepts a design requirement of a system; generates a system configuration plan that satisfies the design requirement; derives threats that are present in the system configuration plan, attack paths that are constituted by a chain of the threats, and countermeasures that are implemented with respect to the threats; and derives a threat consideration priority that represents a priority with which the threats are to be considered, and an attack path consideration priority that represents a priority with which the attack paths are to be considered.

### CROSS-REFERENCE TO RELATED APPLICATIONS

This application is based upon and claims the benefit of priority from Japanese patent application No. 2024-096889, filed on Jun. 14, 2024, the disclosure of which is incorporated herein in its entirety by reference.

### TECHNICAL FIELD

The present disclosure relates to a secure system automated design device, a secure system automated design method, and a storage medium.

### BACKGROUND ART

Ryosuke Hotchi, Takayuki Kuroda, “Secure system automated design technique using security model representation based on threats and countermeasures”, Institute of Electronics, Information and Communication Engineers, Network Virtualization (NV) Study Group, Nov. 21, 2023 [retrieved Jun. 5, 2024], Internet <https://www.ieice.org/cs/nv/wp-content/uploads/2023/11/20231121_NV_Hotchi_NEC.pdf> (Non-Patent Document 1) discloses a technique used to automatically design a secure system configuration (hereinafter referred to as a “secure system automated design technique”). This technique first generates a plurality of system configuration plans, evaluates the security of each system configuration plan, and extracts and outputs system configuration plans that have been evaluated as secure. The system configuration plans that are generated are concrete system configurations, and the security evaluation is carried out based on the concrete system configurations that have been generated.

In the secure system automated design technique described in Non-Patent Document 1, an attack that a system designer of the system automated design wishes to prevent from succeeding, and the means by which an attacker can execute the attack, are described using the concept of a “threat”. In this technique, a comprehensive search is performed with respect to the system configuration plans that are generated during system automated design for the presence of an “attack path”, which is a chained route of threats representing the sequence of steps an attacker executes in order to execute the attack that the system designer side wishes to prevent from succeeding. In this technique, the security measures and functions that are implemented as measures against the threat are described using the concept of a “countermeasure”. In this technique, a countermeasure is expressed in a form that associates the countermeasure with a threat. In a case where a countermeasure is associated with one of the threats constituting an attack path, the attack path is classified as an “invalid attack path”. Further, in a case where a countermeasure is not associated with any of the threats constituting an attack path, the attack path is classified as a “valid attack path”. This technique uses a security classification method where a system configuration plan in which a valid attack path is present is classified as “unsecure”, and a system configuration plan in which no valid attack paths are present is classified as “not unsecure”.

In the technique presented in Non-Patent Document 1, the automated design is performed by comprehensively considering all of the threats and attack paths that are present in a configuration plan. As a result, there is a possibility that the introduction of excessive countermeasures, which are beyond the security measures expected by a user actually using the secure system automated design technique, may be investigated. Furthermore, because the specification considers all of the threats and attack paths that are present in the system configuration plan, and investigates the introduction of all of the countermeasures that can be introduced, there is a possibility that the calculation cost of the secure automated design may increase.

In Japanese Unexamined Patent Application, First Publication No. 2020-052686 (Patent Document 1), a vulnerability evaluation device is disclosed that evaluates the threat level of security holes for each component of a computer device that has been subjected to evaluation, and determines a priority order of security measures. However, in this device, automated design of a secure system configuration is not possible.

### SUMMARY

In order to automatically design a secure system based on the security requirements of a user without introducing excessive security measures, if information that can be compared with the security requirements of the user can be derived from the configuration plan (referred to as a security evaluation value), and the security evaluation value that has been derived satisfies the security requirements of the user, it can be determined that there is no need to introduce additional security measures to the configuration plan. An example object of the present disclosure is to provide a technique that derives a security evaluation value that can be compared with the security requirements of a user when automatically designing a secure system.

According to an example aspect of the present disclosure, a secure system automated design device includes: a means that accepts a design requirement of a system; a means that generates a system configuration plan that satisfies the design requirement; a means that derives threats that are present in the system configuration plan, attack paths that are constituted by a chain of the threats, and countermeasures that are implemented with respect to the threats; and a means that derives a threat consideration priority that represents a priority with which the threats are to be considered, and an attack path consideration priority that represents a priority with which the attack paths are to be considered.

According to an example aspect of the present disclosure, a secure system automated design method includes the steps of: accepting a design requirement of a system; generating a system configuration plan that satisfies the design requirement; deriving threats that are present in the system configuration plan, attack paths constituted by a chain of the threats, and countermeasures that are implemented with respect to the threats; and deriving a threat consideration priority that represents a priority with which the threats are to be considered, and an attack path consideration priority that represents a priority with which the attack paths are to be considered.

According to an example aspect of the present disclosure, a non-transitory storage medium storing a program causes a computer to function as: a means that accepts a design requirement of a system; a means that generates a system configuration plan that satisfies the design requirement; a means that derives threats that are present in the system configuration plan, attack paths constituted by a chain of the threats, and countermeasures that are implemented with respect to the threats; and a means that derives a threat consideration priority that represents a priority with which the threats are to be considered, and an attack path consideration priority that represents a priority with which the attack paths are to be considered.

### BRIEF DESCRIPTION OF THE DRAWINGS

FIG. 1 is a block diagram showing an example of a functional configuration of a secure system automated design device according to a first example embodiment.

FIG. 2 is a diagram showing a legend of the representation methods used in an example of a system configuration plan according to the first example embodiment.

FIG. 3 is a diagram showing an example of a security model according to the first example embodiment.

FIG. 4 is a diagram showing an example of input requirement data according to the first example embodiment.

FIG. 5A is a first diagram showing an example of a system configuration plan in which a countermeasure has not been introduced, which is input to a consideration priority information updating unit according to the first example embodiment.

FIG. 5B is a second diagram showing an example of a system configuration plan in which a countermeasure has not been introduced, which is input to a consideration priority information updating unit according to the first example embodiment.

FIG. 6A is a first diagram showing an example of a system configuration plan in which a countermeasure has been introduced, which is input to a consideration priority information updating unit according to the first example embodiment.

FIG. 6B is a second diagram showing an example of a system configuration plan in which a countermeasure has been introduced, which is input to a consideration priority information updating unit according to the first example embodiment.

FIG. 7 is a diagram showing examples of a system configuration plan immediately after deriving threat consideration priorities according to the first example embodiment.

FIG. 8 is a flowchart showing an operation of the secure system automated design device according to the first example embodiment.

FIG. 9 is a diagram showing an example of a security model according to a second example embodiment.

FIG. 10 is a diagram showing examples of a system configuration plan immediately after deriving threat consideration priorities according to the second example embodiment.

FIG. 11 is a block diagram showing an example of a functional configuration of a secure system automated design device according to a third example embodiment.

FIG. 12 is a flowchart showing an example of an operation of the secure system automated design device according to the third example embodiment.

FIG. 13 is a diagram showing an example of a hardware configuration of a secure system automated design device according to the example embodiments.

### EXAMPLE EMBODIMENT

Hereinafter, a secure system automated design device according to the example embodiments of the present disclosure will be described with reference to the drawings. In the drawings used in the following description, the configurations of sections that are not related to the present disclosure are sometimes omitted, and not illustrated. In each of the drawings, the same or corresponding configurations are assigned the same reference symbols, and common descriptions may sometimes be omitted.

### First Example Embodiment

### (Configuration)

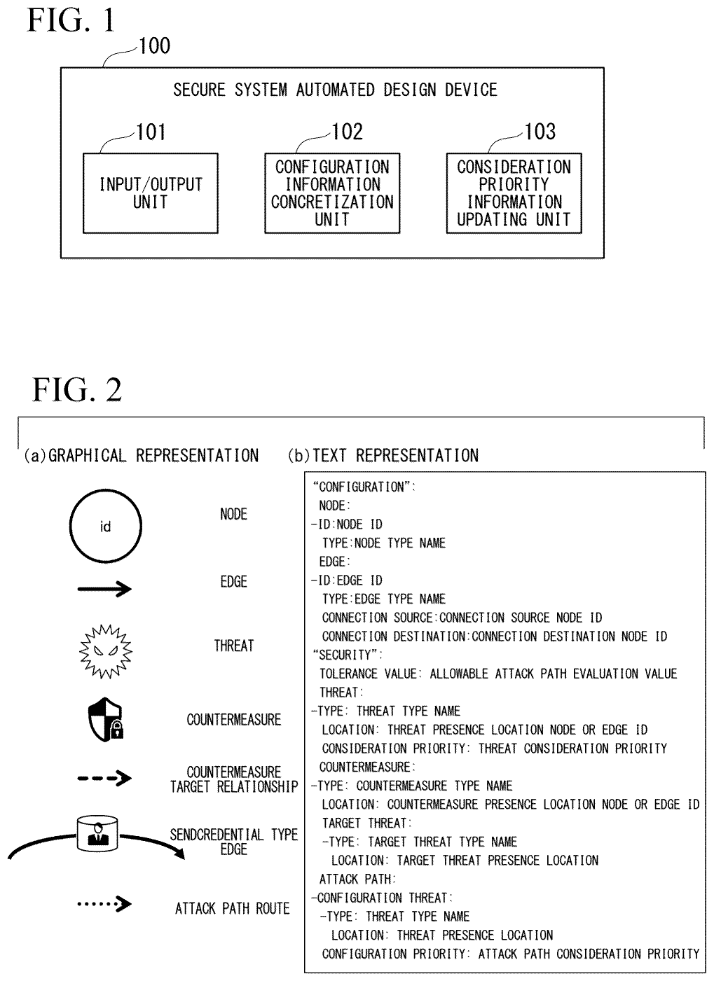

A secure system automated design device according to a first example embodiment of the present disclosure will be described. FIG. 1 is a block diagram showing an example of a functional configuration of the secure system automated design device according to the first example embodiment. As shown in FIG. 1, the secure system automated design device 100 includes an input/output unit 101, a configuration information concretization unit 102, and a consideration priority information updating unit 103.

The input/output unit 101 receives, as an input, requirement data that is subjected to a secure system design, and transmits the requirement data to the configuration information concretization unit 102. Furthermore, the input/output unit 101 receives, from the configuration information concretization unit 102, a system configuration plan in which concretization has been completed, and outputs the system configuration plan to a display device, an electronic file, or the like, as a design result of the secure system design device.

The configuration information concretization unit 102 creates a search tree based on the requirement data received from the input/output unit 101, applies “configuration concretization processing” to the requirement data, and then transmits the data to the consideration priority information updating unit 103 in order to apply various consideration priority information to the threats and attack paths that are present in the generated system configuration plan. A search tree is generated in the process of generating a concrete configuration from the input requirement data, and is represented as a graph having a tree structure with the requirement data as the root node. The leaf nodes represent concretized configuration plans of the system, and include configuration plans that are still in the process of being designed. In the process of searching for a concrete configuration in the search tree, the configuration concretization processing is applied to the leaf nodes representing a concretized configuration plan currently undergoing concretization, and concretized configuration plans in which abstract elements have been partially concretized are generated as the leaf nodes representing the next state. Furthermore, as disclosed in Non-Patent Document 1, the configuration information concretization unit 102, in the process of generating a concrete configuration, derives the threats that are present in the system configuration plan based on a threat model (not shown), derives which types of additional threats are required in the system configuration plan to realize the threats based on the threat realization model (not shown), and adds the derived threats to the system configuration plan. In addition, the configuration information concretization unit 102 combines the added threats and generates an attack path representing a realization method of a cyber attack. Moreover, the configuration information concretization unit 102 adds a valid countermeasure to the system configuration plan based on a countermeasure model (not shown) that defines, with respect to the added threats, which types of countermeasure can be implemented to prevent or mitigate the threats. In this process, the configuration information concretization unit 102 transmits a concretized configuration plan, to which the threats, attack path, and countermeasure have been added, to the consideration priority information updating unit 103. Further, a system configuration plan in which various consideration priority information has been updated is received from the consideration priority information updating unit 103. Then, it is determined whether or not the system configuration plan is unsecure. In a case where the system configuration plan is unsecure, the system configuration plan is rejected. In a case where the system configuration plan is not unsecure, if the system configuration plan is a concrete configuration, the system configuration plan is transmitted to the input/output unit 101 as a design result, and if the system configuration plan is not a concrete configuration, the system configuration plan is added to the search tree. Then, a system configuration plan that is not a concrete configuration is selected from the search tree, and the processing described above is repeated. The “configuration concretization processing”, for example, is disclosed in International Publication No. WO 2019/216082, and is known.

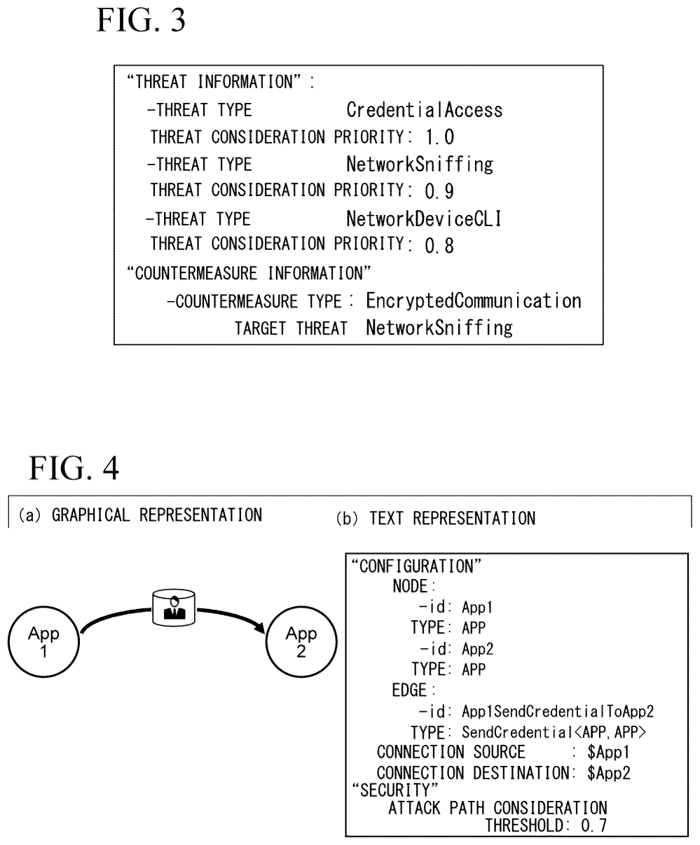

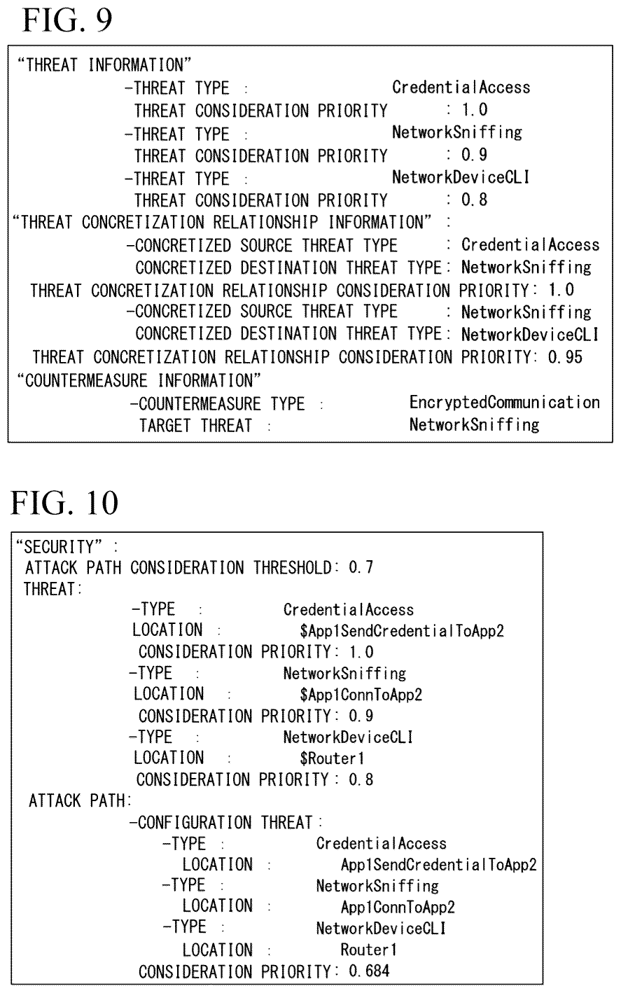

The consideration priority information updating unit 103 receives the system configuration plan from the configuration information concretization unit 102, sets threat consideration priorities with respect to the threats based on the security model described below (see FIG. 3 and FIG. 9), and derives an attack path consideration priority relating to the attack path.

Next, the data handled in the first example embodiment will be described.

FIG. 2 is a legend of the representation methods used in the system configuration plan according to the first example embodiment. (a) of FIG. 2 is a legend of the graphical representation, and (b) of FIG. 2 is a legend of the textual representation. The system configuration plan is represented by nodes that represent the components constituting the system, and edges that represent the relationship between two components. As shown in (a) of FIG. 2, in the graphical representation of the system configuration plan, the nodes are represented by circles, and the edges are represented by solid arrows. An id for identifying the individual nodes is written inside the circles representing the nodes. Among the edges, a “SendCredential type” edge is specifically represented using a curved arrow with a graphic displaying a cylindrical icon with an icon of a person. Furthermore, as shown in (a) of FIG. 2, in the graphical representation, a threat is represented using a virus icon, and a countermeasure is represented using an icon in which a padlock mark is drawn on top of a shield. The correspondence indicating which countermeasure prevents or mitigates which threat is indicated by a dashed arrow. Further, the chained route of threats that constitute an attack path (concretized relationships indicating which threat is concretized by which threat) is indicated by dotted arrows.

The text description example of the system configuration plan is created in accordance with the YAML format. In (b) of FIG. 2, as the information about the system configuration plan, fields are present that list information relating to the configuration and security. As the configuration information, information about the nodes and edges is shown. As the security information, information about the tolerance value, threats, countermeasure, and attack path is shown. In (b) of FIG. 2, as the information about each node that is present in the system configuration plan, an id and a type name are listed. As the information about each edge, an id, a type name, an edge connection source node id, and an edge connection destination node id are listed. As the information about the threats, a type name, an existence location, and a threat consideration priority is listed. As the information about the countermeasure, a countermeasure type name, a countermeasure existence location, a target threat type name, and a target threat existence location are listed. As the information about the attack path, a type name and an existence location for all of the threats constituting the attack path, and an attack path consideration priority are listed. The threat consideration priority in the threat field and the attack path consideration priority in the attack path field are provided to the consideration priority information updating unit 103 based on the security model shown in FIG. 3, which will be described next. In the present disclosure, it is assumed that each type of consideration priority is represented by a continuous quantitative value from 0.0 to 1.0. The target threat in the countermeasure field refers to the threat subjected to prevention or mitigation by the countermeasure. Furthermore, as shown in (b) of FIG. 2, in the present disclosure, a tolerance value can be defined as security information in the system configuration plan. The value of the tolerance value is a continuous quantitative value from 0.0 to 1.0 that is defined as an input requirement of the secure system automated design technique. In a case where the value is defined, it is possible to use the attack path tolerance value in a security classification of the system configuration plan.

FIG. 3 shows an example of a security model used in the first example embodiment. The security model shown in FIG. 3 lists information relating to the threats and the countermeasure. In FIG. 3, fields that describe both the threat information and the countermeasure information are present. As the threat information, a type name and a consideration priority are listed. As the countermeasure information, a type name and a target threat are listed. The consideration priority of a threat holds a continuous quantitative value in a range from 0.0 to 1.0, and is a parameter used when deriving the threat consideration priorities of the threats that are actually present in the system configuration plan. The security model illustrated in FIG. 3 is stored such that the security model can be referenced from the configuration information concretization unit 102 and the consideration priority information updating unit 103.

FIG. 4 shows an example of requirement data that is input to the secure system automated design device in the first example embodiment. (a) of FIG. 4 is an example showing the requirement data as a diagram, and (b) of FIG. 4 is an example showing the same requirement data as text. The requirement data shown in FIG. 4 shows a configuration in which there are two APP type nodes, App1 and App2, and the nodes are connected by a SendCredential<APP, APP> type edge. Furthermore, as the security requirement information, an attack path consideration threshold of 0.7 is input. The attack path consideration threshold is referenced by the configuration information concretization unit 102 together with the attack path consideration priority. In a case where an attack path consideration threshold is defined in the requirement data, an attack path having a lower attack path consideration priority than the threshold is set to “not considered”, and the introduction of a countermeasure with respect to the attack path is not investigated. Further, even if the attack path is a “valid attack path” the system is classified as “not unsecure”.

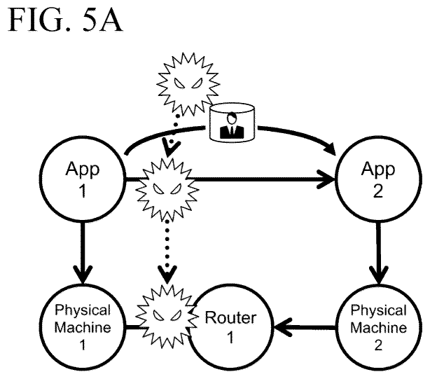

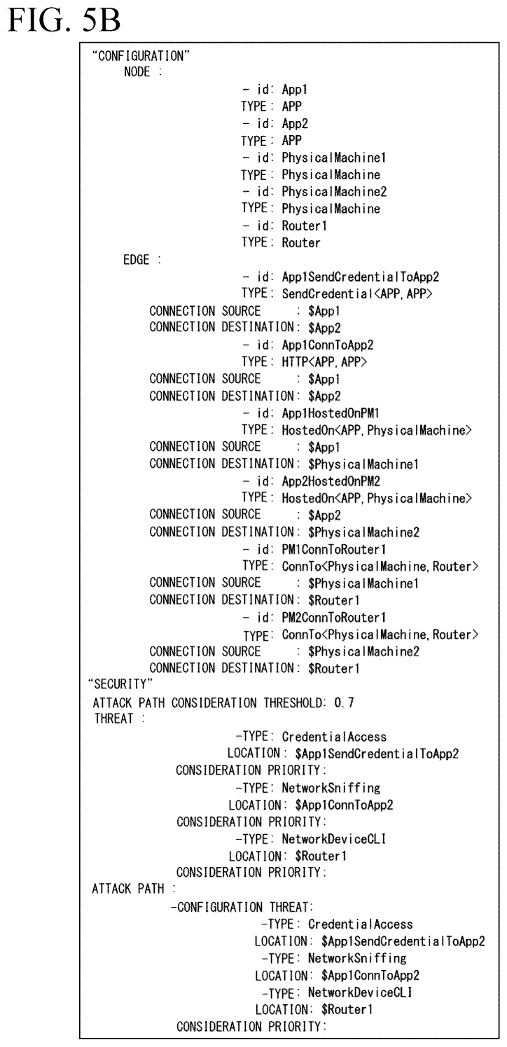

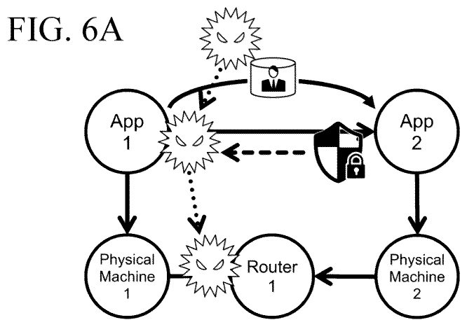

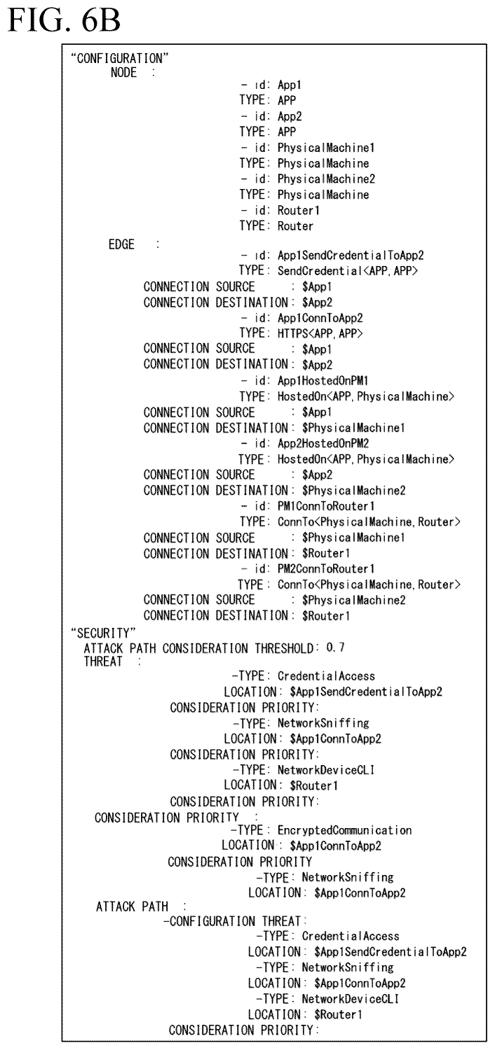

FIG. 5A to FIG. 6B are examples of system configuration plans that are input to the consideration priority information updating unit 103 in the first example embodiment. FIG. 5A and FIG. 5B show an example of a system configuration plan in which a countermeasure has not been introduced. FIG. 6A and FIG. 6B show an example of a system configuration plan in which a countermeasure has been introduced. FIG. 5A and FIG. 6A are graphical representations of each system configuration plan. FIG. 5B and FIG. 6B are textual representations of each system configuration plan.

FIG. 5A and FIG. 5B show a scheme in which, in order for two APP type applications to communicate, the two applications App1 and App2 are hosted on PhysicalMachine1 and PhysicalMachine2, respectively, which are PhysicalMachine type physical machines, and a Router type router (Router1) is connected to the two physical machines. Furthermore, the schemes show that a CredentialAccess type threat is present on the SendCredential type edge connecting App1 and App2, a NetworkSniffing type threat is present on the HTTP type edge connecting App1 and App2, and a NetworkDeviceCLI type threat is present on Router1. In addition, the scheme shows that the concretized destination of the CredentialAccess type threat is the NetworkSniffing type threat, and the concretized destination of the NetworkSniffing type threat is the NetworkDeviceCLI type threat. Also, a valid attack path is established when the route connecting the CredentialAccess type threat, the NetworkSniffing type threat, and the NetworkDeviceCLI type threat indicated by the dashed arrow is established, which causes the system to become unsecure.

The system configuration plan example shown in FIG. 6A and FIG. 6B is almost identical to the configuration in FIG. 5A and FIG. 5B, and only differs in that an HTTPS type edge is present instead of the HTTP type edge connecting App1 and App2, a NetworkSniffing type threat and an EncryptedCommunication type countermeasure are each present on the HTTPS type edge, and the countermeasure is subjecting the threat to mitigation. As shown in FIG. 6A, in a case where a countermeasure is implemented with respect to the NetworkSniffing type threat, and the route connecting the CredentialAccess type threat, the NetworkSniffing type threat, and the NetworkDeviceCLI type threat indicated by the dashed arrow is blocked, the attack path becomes invalid, and the system is not necessarily unsecure.

The information relating to security threats and countermeasures listed in FIG. 5A to FIG. 6B may be provided as a system requirement (requirement data). For example, the configuration information concretization unit 102 may include a function that refers to the security model illustrated in FIG. 3 in the concretization process, and generates threat and countermeasure information, and generates the information from the requirement data in (a) of FIG. 4 and (b) of FIG. 4 using the function. In addition to Non-Patent Document 1, the generation of threat information is disclosed in, for example, example embodiment 2 of International Publication No. WO 2023/042257 (paragraph 0041 onwards), in which a threat model (not shown) is defined such that the threat information is automatically generated when specific components and relationships (nodes and edges) are present in a system configuration plan, and the threat information may be generated by referring to the threat model. Furthermore, in addition to Non-Patent Document 1, the generation of countermeasure information is disclosed in, for example, Japanese Unexamined Patent Application, First Publication No. 2023-098467, and may be performed based on “Countermeasure Information” (FIG. 5B in Japanese Unexamined Patent Application, First Publication No. 2023-098467) described under countermeasure models. For example, the “countermeasure information” at least includes information about the “type” and “target threat”, and when a “target threat” is present in a certain system configuration plan, the countermeasure information may be generated in a form such that the countermeasure of the type specified under “type” is associated with the “target threat”.

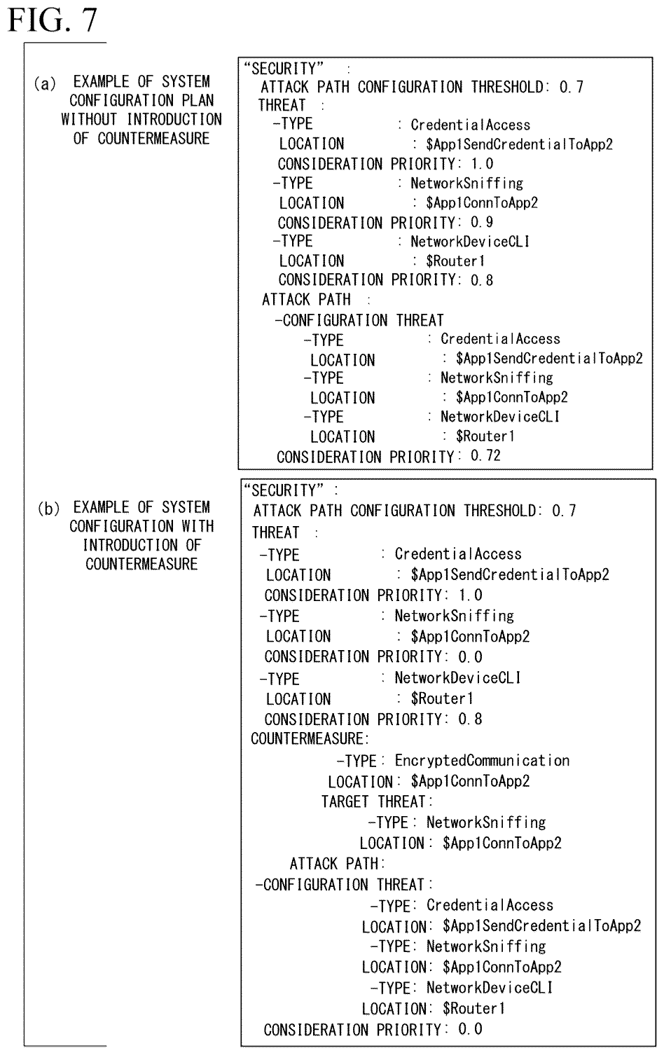

FIG. 7 shows, in the first example embodiment, a result in which the threat consideration priorities and the attack path consideration priority have been derived and reflected by the consideration priority information updating unit 103 with respect to the system configuration plan examples shown in FIG. 5A to FIG. 6B. (a) of FIG. 7 shows the result of updating each of the various types of consideration priority information in the system configuration plan in FIG. 5, and (b) of FIG. 7 shows the result of updating each of the various types of consideration priority information in the system configuration plan in FIG. 6.

In (a) of FIG. 7, the consideration priorities of the threat information listed in the security model example shown in FIG. 3 are transferred as is for the three threats listed in the threat field. In the example of the present example embodiment, the attack path consideration priority is derived as the product of the threat consideration priorities of all of the threats that constitute the attack path. In the example shown in (a) of FIG. 7, the only attack path that is present is constituted by three threats, namely a “CredentialAccess type threat present on $App1SendCredentialToApp2”, a “NetworkSniffing type threat present on $App1ConnToApp2”, and a “Network DeviceCLI type threat present on $Router1”. Therefore, the threat consideration priorities of the threats constituting the attack path are “1.0”, “0.9”, and “0.8”, respectively. Therefore, the attack path consideration priority of the attack path is “1.0×0.9×0.8=0.72”. Consequently, in the example shown in (a) of FIG. 7, a numerical value of 0.72 is placed in the attack path priority field of the attack path. The attack path consideration threshold shown in (a) of FIG. 7 is 0.7, and the attack path consideration priority of the attack path of 0.72 is not a lower value than the attack path threshold. Therefore, the attack path is not set to “not considered”.

The example of (b) of FIG. 7 differs from the example of (a) of FIG. 7 in that an EncryptedCommunication type countermeasure is present that targets the “NetworkSniffing type threat present on $App1ConnToApp2”. In the example of the present example embodiment, the threat consideration priorities in the system configuration plan are set to the same value as the value defined in the security model in cases where a countermeasure is not associated with the threat, and set to 0.0 and interpreted as “a threat that has been prevented from succeeding due to a countermeasure” in cases where a countermeasure is associated with the threat. Therefore, the threat consideration priorities of the two threats in which a countermeasure is not associated with the threat, namely the “CredentialAccess type threat present on $App1SendCredentialToApp2” and the “NetworkDeviceCLI type threat present on $Router1” are set to “1.0” and “0.8”, respectively, which are the same values as in the example of (a) of FIG. 7. The threat consideration priority of the “NetworkSniffing type threat present on $App1ConnToApp2” associated with the countermeasure is “0.0”. In addition, in the example of the present example embodiment, the attack path consideration priority is derived as the product of the threat consideration priorities of all of the threats that constitute the attack path. Therefore, the attack path consideration priority of the attack path in the example of (b) of FIG. 7 is “1.0×0.0×0.8=0.0”. Consequently, a numerical value of 0.0 is placed in the attack path priority field of the attack path. Furthermore, the attack path consideration threshold shown in (b) of FIG. 7 is 0.7, and the attack path consideration priority of the attack path of 0.0 is a lower value than the attack path threshold. Therefore, the attack path is set to “not considered”. Therefore, in the configuration plan generated by applying the configuration concretization processing to the configuration plan example in (b) of FIG. 7, the introduction of additional countermeasures relating to the three threats constituting the attack path is not considered.

### (Operation)

Next, the operation of the first example embodiment of the secure system automated design device will be described.

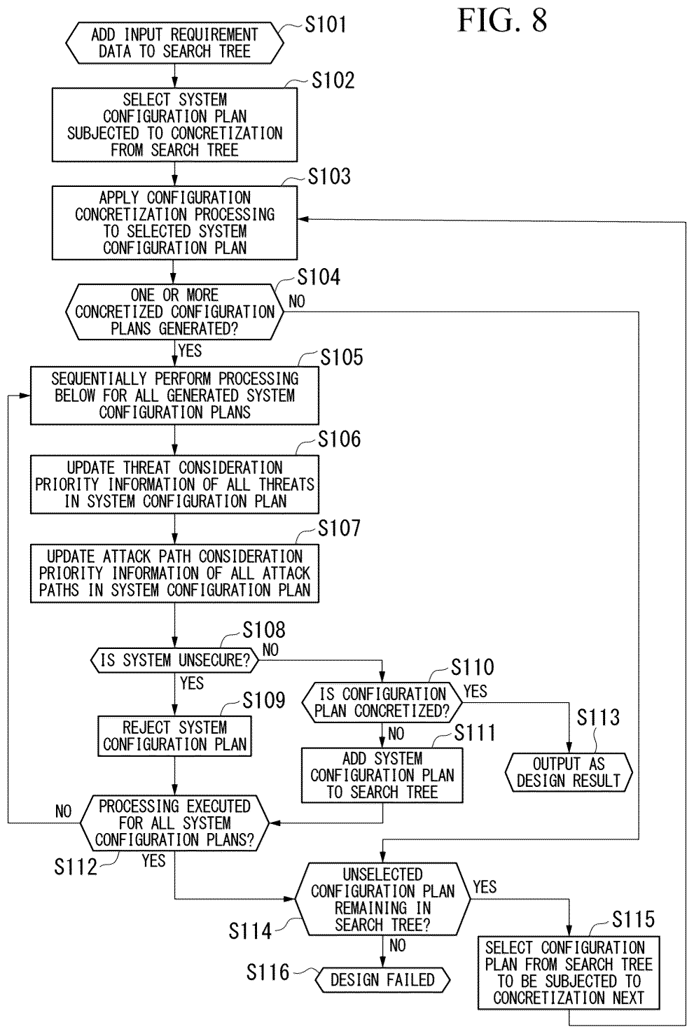

FIG. 8 is a flowchart showing the operation of the secure system automated design device according to the first example embodiment.

First, the input/output unit 101 receives requirement data that has been input by a user or from another system that defines the requirements to be included in the automatically designed system, and adds the requirement data to the search tree (step S101). For example, the requirement data illustrated in FIG. 4 is input. Then, the input/output unit 101 transmits the information of the search tree to the configuration information concretization unit 102. Then, the configuration information concretization unit 102 selects one system configuration plan to be subjected to concretization from within the search tree (step S102). The system configuration plan that is targeted is arbitrary. However, it is possible to use the attack path consideration priority in the system configuration plan as a selection index to decide which system configuration plan is to be targeted (although the attack path consideration priority is initially not set, the attack path consideration priority is derived and set by the consideration priority information updating unit 103 in the concretization process. For example, a system configuration plan whose attack path consideration priority is the largest or smallest, or the first system configuration plan whose attack path consideration priority is larger than a predetermined value that is found first, may be selected). Once the target system configuration plan is selected, the configuration plan concretization processing is performed with respect to the system configuration plan (step S103). In the configuration plan concretization processing, information about the countermeasures used with respect to the threats, and the like, is generated. System configuration plans that have been subjected to concretization have been illustrated in FIG. 5A to FIG. 6B. As a result, it is determined whether or not one or more concretized system configuration plans have been generated (step S104). In a case where one or more concretized configuration plans have been generated (Yes in step S104), the processing proceeds to step S105. In a case where no system configuration plans have been generated (No in step S104), the processing proceeds to the classification in step S114.

In a case where one or more system configuration plans have been generated in the configuration information concretization processing, all of the system configuration plans are transmitted to the consideration priority information updating unit 103, and threat consideration priority information updating processing and attack path consideration priority information updating processing are executed in turn with respect to all of the system configuration plans (step S105). First, updating processing of the threat consideration priority information is executed with respect to a concretized configuration plan (step S106). The consideration priority information updating unit 103 refers to the security model illustrated in FIG. 3, and sets a consideration priority with respect to each threat included in the system configuration plan. At this time, as described in FIG. 7, if a countermeasure has been formulated with respect to a threat, the consideration priority information updating unit 103 sets a consideration priority of “0.0” to the threat. Then, updating processing of the attack path consideration priority information is executed with respect to the system configuration plan (step S107). The consideration priority information updating unit 103 multiplies the consideration priority set to each threat to calculate the consideration priority of the attack path, and updates the item with the calculated value. When the updating of the attack path consideration priority information of the system configuration plan is completed, the result is transmitted to the configuration information concretization unit 102, and it is determined whether or not the system configuration plan is unsecure (step S108). For example, the configuration information concretization unit 102 compares the consideration priorities of all of the attack paths that have been updated by the consideration priority information updating unit 103 and the attack path consideration threshold. Then, if the consideration priority of any of the attack paths is greater than or equal to the attack path consideration threshold, the system configuration plan is classified as “unsecure”. Alternatively, if the consideration priority of all of the attack paths is less than the attack path consideration threshold, it is determined that the system configuration plan is “not unsecure”. In addition, the configuration information concretization unit 102 determines that the system configuration plan is “not unsecure” in a case where an attack path is not present. In a case where the classification result is “non-secure” (Yes in step S108), the system configuration plan is rejected (step S109). In a case where the classification result is “not unsecure” (No in step S108), it is investigated whether or not the system configuration plan is a concrete configuration plan (step S110). The “unsecure” referred to here includes cases in which a valid attack path is not present, or all valid attack paths that are present are classified as “not considered”. Furthermore, the “concrete configuration plan” referred to here specifies a configuration plan in which all of the components constituting the system are configured as specific nodes and edges, while also satisfying all of the requirements indicated in the requirement data initially input to the input/output unit 101. In a case where the system configuration plan is concrete (Yes in step S110), the configuration information concretization unit 102 transmits the system configuration plan to the input/output unit 101, and outputs the system configuration plan as the design result of the secure system automated design device (step S113). On the other hand, if the system configuration plan is not concrete (No in step S110), the configuration information concretization unit 102 adds the system configuration plan to the search tree (step S111).

After performing the processing of step S109 or step S111, it is investigated whether or not the series of processing from the threat consideration priority information updating processing (step S106) to the security classification (step S109 or step S111) has been performed with respect to all of the system configuration plans generated in the configuration information concretization processing (step S112). In a case where a system configuration plan is present in which the series of processing has not yet been applied (No in step S112), the processing returns to step S105 and is repeated. In a case where a system configuration plan is not present in which the series of processing has not yet been applied (Yes in step S112), it is investigated whether or not there are any system configuration plans in the search tree that have not been selected as the target of the configuration concretization processing (step S114). In a case where no unselected system configuration plans are remaining in the search tree (No in step S114), there are no remaining ways in the secure system automated design device for the requirement data to be concretized while satisfying the security requirements, and an output indicating that the design failed is output from the input/output unit 101 (step S116). In a case where unselected system configuration plans are remaining in the search tree (Yes in step S114), the system configuration plan to be subjected to concretization next is once again selected from the search tree (step S115), the processing returns to step S103, and the configuration information concretization processing is repeated. In a similar manner to step S102, the configuration information concretization unit 102 is capable of selecting a system configuration plan from the search tree using the attack path consideration priority.

### (Effects)

According to the first example embodiment described above, a tolerance value (attack path consideration threshold) is set in the requirement data as the security information of a system configuration plan, and then system concretization and security classification are performed. In the security classification, if the validity of the attack path (consideration priority of the attack path) is within the range of the tolerance value, the system configuration plan is classified as not unsecure, and is a valid system configuration plan that satisfies the requirements of the user. In other words, it is possible to automatically design a secure system by limiting the threats and attack paths that need to be addressed based on the security requirements of the user. As a result, it is possible to prevent searches for systems in which excessive security measures have been introduced.

### Second Example Embodiment

The second example embodiment is different from the first example embodiment in that “threat concretization relationship consideration priorities” are also used to derive the attack path consideration priority.

### (Configuration)

The configuration of the secure system automated design device 100 according to the second example embodiment is the same as the configuration of the first example embodiment illustrated in FIG. 1. Next, the data handled in the second example embodiment will be described. The legend of the representation methods used in the example of the system configuration plan handled in the second example embodiment is the same as in the first example embodiment, and is shown in FIG. 2. FIG. 9 shows an example of a security model used in the second example embodiment. The example of the security model shown in FIG. 9 differs from FIG. 3 in that a field that describes threat concretization relationship information is present. In the example shown in FIG. 9, it is shown that, in a case where the CredentialAccess type threat to the NetworkSniffing type threat has been concretized, the threat concretization relationship consideration priority assigned to the threat concretization relationship is 1.0, and in a case where the NetworkSniffing type threat to the NetworkDeviceCLI type threat has been concretized, the threat concretization relationship consideration priority assigned to the threat concretization relationship is 0.95. For example, the threat consideration priority of the threat information is set with a probability of the single threat being executed, and the threat concretization relationship consideration priority can be set with the probability that the attacker executes the concretization source threat after executing the concretization destination threat. The threat concretization relationship consideration priority is a parameter for reflecting, for example, when two types of threat concretization relationships such as threat A→threat X and threat B→threat X are present, a difference in the occurrence rate of each concretized relationship in the consideration priority of the attack path. For example, if the threat concretization of threat A→threat X is likely to occur in reality, but threat B→threat X is a rare case that is not observed very often, the threat concretization relationship consideration priority is used by setting a lower value for the latter than the former. That is, the probability of executing the concretization source threat after executing the concretization destination threat varies depending on various factors such as the threat type of the concretization source or the concretization destination, or the presence location in the topology, and therefore, the threat concretization relationship consideration priority is a parameter for reflecting the variation. As a result of introducing the threat concretization relationship consideration priorities, the threats can be more realistically evaluated and scored.

FIG. 10 is a textual representation of a result in which the threat consideration priorities and attack path consideration priority have been derived and reflected by the consideration priority information updating unit 103 with respect to the system configuration plan example shown in FIG. 5. The example shown in FIG. 10 basically has the same content as that shown in (a) of FIG. 7, with a difference in that the value of the attack path consideration priority is 0.684. In the example of the present example embodiment, the attack path consideration priority is derived as the product of a product of the threat consideration priorities of all of the threats constituting the attack path, and a product of the threat concretization relationship consideration priorities of all of the threat concretization relationships connecting the threats. In the example shown in FIG. 10, the only attack path that is present is constituted by three threats, namely a “CredentialAccess type threat present on $App1SendCredentialToApp2”, a “NetworkSniffing type threat present on $App1ConnToApp2”, and a “NetworkDeviceCLI type threat present on $Router1”. The threat consideration priorities of the threats constituting the attack path are “1.0”, “0.9”, and “0.8”, respectively. Therefore, the product of the threat consideration priorities is “1.0×0.9×0.8=0.72”. Furthermore, the threat concretization relationship connecting the threats constituting the attack path are the two relationships “from the CredentialAccess type threat present on $App1SendCredentialToApp2 to the NetworkSniffing type threat present on $App1ConnToApp2”, and “from the NetworkSniffing type threat present on the $App1ConnToApp2 to the NetworkDeviceCLI type threat present on $Router1”. The consideration priorities of the threat concretization relationships are “1.0” and “0.95” as shown in FIG. 9. Therefore, the product of the threat concretization relationship consideration priorities is “1.0×0.95=0.95”. As a result, the product of the product of the threat consideration priority of all of the threats constituting the attack path, and the product of the threat concretization relationship consideration priority of all of the threat concretization relationships connecting the threats is “0.72×0.95=0.684”, and in the example shown in FIG. 10, a numerical value of 0.72 is placed in the consideration priority field of the attack path. The attack path consideration threshold shown in FIG. 10 is 0.7, and the attack path consideration priority of the attack path of 0.684 is a lower value than the attack path threshold. Therefore, the attack path is set to “not considered”.

### (Operation)

Next, the operation of the second example embodiment will be described. The operation of the second example embodiment is basically the same as the operation of the first example embodiment. The flowchart showing the operation of the second example embodiment is the same as that shown in FIG. 8. The difference from the operation of the first example embodiment is the updating method of the attack path consideration priority information (step S107). In the second example embodiment, the attack path consideration priority is derived, by the consideration priority information updating unit 103, as the product of the product of the threat consideration priorities of all of the threats constituting the attack path, and the product of the threat concretization relationship consideration priorities of all of the threat concretization relationships connecting the threats. At this time, in a similar manner to the first example embodiment, if a countermeasure has been formulated with respect to a threat, a consideration priority of “0.0” is set to the threat. All other operations (steps S101 to S106, and steps S108 to S116) are the same as those described in the first example embodiment.

### (Effects)

As described above, according to the second example embodiment, in a similar manner to the first example embodiment, by deriving a security evaluation value (attack path consideration priority) that can be compared with the security requirements (tolerance value) of the user, it is possible to automatically design a secure system based on the security requirements of the user without introducing excessive security measures. Furthermore, as a result of calculating the attack path consideration priority by introducing threat concretization relationship information, it is possible to determine whether or not the system is “unsecure” by performing a more realistic evaluation with respect to the threats in the system configuration plan.

### Third Example Embodiment

FIG. 11 is a block diagram showing an example of a functional configuration of a secure system automated design device according to a third example embodiment.

The secure system automated design device 800 includes: an acceptance means 801 that accepts a design requirement of a system that includes a tolerance value of a security requirement to be satisfied by the system; a generation means 802 that generates a system configuration plan that satisfies the design requirement; a threat derivation means 803 that derives threats that are present in the system configuration plan, attack paths constituted by a chain of the threats, and countermeasures that are implemented with respect to the threats; and an evaluation value derivation means 804 that derives a threat consideration priority that represents a priority with which the threats are to be considered, and an attack path consideration priority that represent a priority with which the attack paths are to be considered.

An attack path tolerance value is an example of a tolerance value of a security requirement to be satisfied by the system. The input/output unit 101 is an example of the acceptance means 801. The configuration information concretization unit 102 is an example of the generation means 802 and the threat derivation means 803. The consideration priority information updating unit 103 is an example of the evaluation value derivation means 804.

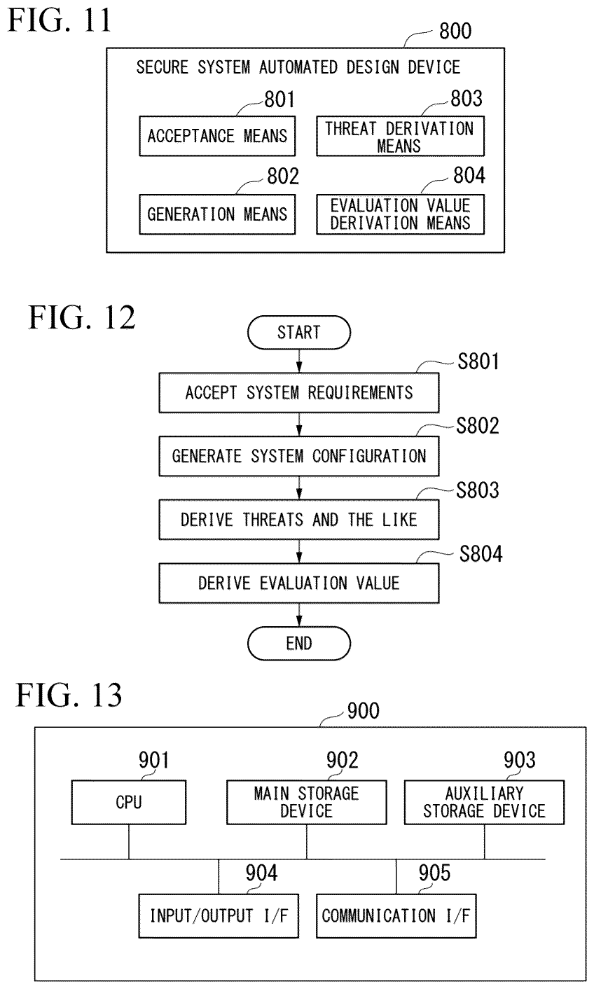

FIG. 12 is a flowchart showing an example of the operation of the secure system automated design device according to the third example embodiment.

The acceptance means 801 accepts a system design requirement that contains a tolerance value of a security requirement to be satisfied by the system (step S801). The generation means 802 generates a system configuration plan that satisfies the design requirement (step S802). The threat derivation means 803 derives threats that are present in the system configuration plan, attack paths constituted by a chain of the threats, and countermeasures that are implemented with respect to the threats (step S803). The evaluation value derivation means 804 derives a threat consideration priority that represents a priority with which the threats are to be considered, and an attack path consideration priority that represent a priority with which the attack paths are to be considered (step S804).

FIG. 13 is a diagram showing an example of a hardware configuration of a secure system automated design device according to the example embodiments. A computer 900 includes a CPU 901, a main storage device 902, an auxiliary storage device 903, an input/output interface 904, and a communication interface 905. The secure system automated design devices 100 and 800 described above are implemented by the computer 900. Further, the functions described above are stored in the auxiliary storage device 903 in the form of a program. The CPU 901 reads the program from the auxiliary storage device 903, expands the program in the main storage device 902, and executes the processing described above according to the program. In addition, the CPU 901 secures a storage area in the main storage device 902 according to the program. Moreover, the CPU 901 secures, according to the program, a storage area in the auxiliary storage device 903 that stores data during the processing.

A program for realizing some or all of the functions of the secure system automated design devices 100 and 800 may be recorded in a computer-readable recording medium, and the processing by each functional unit may be performed by a computer system reading and executing the program recorded in the recording medium. The “computer system” referred to here is assumed to include an OS and hardware such as a peripheral device. Furthermore, in a case where a WWW system is used, the “computer system” is assumed to include a homepage providing environment (or display environment). Moreover, the “computer-readable recording medium” refers to a portable medium such as a CD, a DVD, or a USB, or a storage device such as a hard disk built into a computer system. In addition, in a case where the program is transmitted to the computer 900 by a communication line, the computer 900 receiving the transmission may expand the program to the main storage device 902, and then execute the processing. Also, the program may be one capable of realizing some of the functions described above. Further, the functions described above may be realized in combination with a program already recorded in the computer system.

An example embodiment of the present disclosure has been described in detail above with reference to the drawings. However, specific configurations are in no way limited to those described above, and various design changes and the like can be made within a scope not departing from the spirit of the present disclosure. Furthermore, each of the example aspects of the present disclosure can be modified in various ways within the scope of the claims, and example embodiments obtained by appropriately combining the technical means disclosed in each of the different example embodiments are also included in the technical scope of the present disclosure. Moreover, configurations in which elements described in the above example embodiments and modifications have been replaced with elements that provide the same effects are also included. In addition, each of the example embodiments may be combined as appropriate with other example embodiments.

The whole or part of the example embodiments above can be described as the supplementary notes below, but the example embodiments are not limited thereto.

According to the present disclosure, a security evaluation value can be derived that can be compared with the security requirements of a user.

While preferred example embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

### (Supplementary Note 1)

A secure system automated design device comprising: a means that accepts a design requirement of a system; a means that generates a system configuration plan that satisfies the design requirement; a means that derives threats that are present in the system configuration plan, attack paths that are constituted by a chain of the threats, and countermeasures that are implemented with respect to the threats; and a means that derives a threat consideration priority that represents a priority with which the threats are to be considered, and an attack path consideration priority that represents a priority with which the attack paths are to be considered.

### (Supplementary Note 2)

The secure system automated design device according to supplementary note 1, wherein the means that derives an attack path consideration priority derives the attack path consideration priority for all of the threats that are present in the system configuration plan by referring to security model information, and derives the attack path consideration priority for all of the attack paths based on information about the threats and the countermeasure that is present in the system configuration plan.

### (Supplementary Note 3)

The secure system automated design device according to supplementary note 1 or 2, wherein the means that derives an attack path consideration priority derives the attack path consideration priority for all of the threats that are present in the system configuration plan by referring to security model information, while also deriving a threat concretization relationship consideration priority that represents a priority with which a relationship between the threats is to be considered, and derives the attack path consideration priority for all of the attack paths based on information about the threats, the countermeasures, and the relationships between the threats that is present in the system configuration plan.

### (Supplementary Note 4)

The secure system automated design device according to any one of supplementary notes 1 to 3, wherein the means that accepts the design requirement of the system accepts a tolerance value of a security of the system, the means that generates the system configuration plan compares the attack path consideration priority for each attack path and the tolerance value, and determines that the system configuration plan is not unsecure if all of the attack path consideration priorities are less than the tolerance value.

### (Supplementary Note 5)

The secure system automated design device according to any one of supplementary notes 1 to 4, wherein the means that accepts the design requirement of the system accepts a tolerance value of a security of the system, and the means that derives a countermeasure compares the attack path consideration priority of each attack path with the tolerance value, and does not derive the countermeasure for an attack path in which the attack path consideration priority is less than the tolerance value.

### (Supplementary Note 6)

The secure system automated design device according to supplementary note 2, wherein the means that derives an attack path consideration priority derives the attack path consideration priority by multiplying the threat consideration priority derived for all of the threats constituting the attack path, and sets the threat consideration priority of the threats for which a countermeasure has been derived at that time to 0.

### (Supplementary Note 7)

The secure system automated design device according to supplementary note 3, wherein the means that derives an attack path consideration priority derives the attack path consideration priority by multiplying the threat consideration priority derived for all of the threats constituting the attack path, and a threat concretization relationship consideration priority derived for the relationships between all of the threats constituting the attack path, and sets the threat consideration priority of the threats for which a countermeasure has been derived at that time to 0.

### (Supplementary Note 8)

A secure system automated design method that causes a secure system automated design device to perform the steps of: accepting a design requirement of a system; generating a system configuration plan that satisfies the design requirement; deriving threats that are present in the system configuration plan, attack paths that are constituted by a chain of the threats, and countermeasures that are implemented with respect to the threats; and deriving a threat consideration priority that represents a priority with which the threats are to be considered, and an attack path consideration priority that represents a priority with which the attack paths are to be considered.

### (Supplementary Note 9)

A program that causes a computer to function as: a means that accepts a design requirement of a system; a means that generates a system configuration plan that satisfies the design requirement; a means that derives threats that are present in the system configuration plan, attack paths that are constituted by a chain of the threats, and countermeasures that are implemented with respect to the threats; and a means that derives a threat consideration priority that represents a priority with which the threats are to be considered, and an attack path consideration priority that represents a priority with which the attack paths are to be considered.

What is claimed is:

1. A secure system automated design device comprising:
at least one memory configured to store instructions; and
at least one processor configured to execute the instructions to:
accept a design requirement of a system;
generate a system configuration plan that satisfies the design requirement;
derive threats that are present in the system configuration plan, attack paths that are constituted by a chain of the threats, and countermeasures that are implemented with respect to the threats; and
derive a threat consideration priority that represents a priority with which the threats are to be considered, and an attack path consideration priority that represents a priority with which the attack paths are to be considered.

2. The secure system automated design device according to claim 1, wherein the at least one processor is configured to execute the instructions to:
derive the attack path consideration priority for all of the threats that are present in the system configuration plan by referring to security model information; and
derive the attack path consideration priority for all of the attack paths based on information about the threats and the countermeasure that is present in the system configuration plan.

3. The secure system automated design device according to claim 1, wherein the at least one processor is configured to execute the instructions to:
derive the attack path consideration priority for all of the threats that are present in the system configuration plan by referring to security model information, while also deriving a threat concretization relationship consideration priority that represents a priority with which a relationship between the threats is to be considered; and
derive the attack path consideration priority for all of the attack paths based on information about the threats, the countermeasures, and the relationships between the threats that is present in the system configuration plan.

4. The secure system automated design device according to claim 1, wherein the at least one processor is configured to execute the instructions to:
accept a tolerance value of a security of the system;
compare the attack path consideration priority for each attack path and the tolerance value; and
determine that the system configuration plan is not unsecure if all of the attack path consideration priorities are less than the tolerance value.

5. The secure system automated design device according to claim 4, wherein the at least one processor is configured to execute the instructions to:
compare the attack path consideration priority of each attack path with the tolerance value; and
do not derive the countermeasure for an attack path in which the attack path consideration priority is less than the tolerance value.

6. The secure system automated design device according to claim 2, wherein the at least one processor is configured to execute the instructions to:
derive the attack path consideration priority by multiplying the threat consideration priority derived for all of the threats constituting the attack path; and
set the threat consideration priority of the threats for which a countermeasure has been derived to a value lower than an attack path threshold.

7. The secure system automated design device according to claim 3, wherein the at least one processor is configured to execute the instructions to:
derive the attack path consideration priority by multiplying the threat consideration priority derived for all of the threats constituting the attack path, and a threat concretization relationship consideration priority derived for the relationships between all of the threats constituting the attack path; and
set the threat consideration priority of the threats for which a countermeasure has been derived to a value lower than an attack path threshold.

8. A secure system automated design method that causes a secure system automated design device to perform:
accepting a design requirement of a system;
generating a system configuration plan that satisfies the design requirement;
deriving threats that are present in the system configuration plan, attack paths constituted by a chain of the threats, and countermeasures that are implemented with respect to the threats; and
deriving a threat consideration priority that represents a priority with which the threats are to be considered, and an attack path that are consideration priority that represents a priority with which the attack paths are to be considered.

9. The secure system automated design method according to claim 8, further comprising:
deriving the attack path consideration priority for all of the threats that are present in the system configuration plan by referring to security model information; and
deriving the attack path consideration priority for all of the attack paths based on information about the threats and the countermeasure that is present in the system configuration plan.

10. The secure system automated design method according to claim 8, further comprising:
deriving the attack path consideration priority for all of the threats that are present in the system configuration plan by referring to security model information, while also deriving a threat concretization relationship consideration priority that represents a priority with which a relationship between the threats is to be considered; and
deriving the attack path consideration priority for all of the attack paths based on information about the threats, the countermeasures, and the relationships between the threats that is present in the system configuration plan.

11. The secure system automated design method according to claim 8, further comprising:
accepting a tolerance value of a security of the system;
comparing the attack path consideration priority for each attack path and the tolerance value; and
determining that the system configuration plan is not unsecure if all of the attack path consideration priorities are less than the tolerance value.

12. The secure system automated design method according to claim 11, further comprising:
comparing the attack path consideration priority of each attack path with the tolerance value; and
doing not derive the countermeasure for an attack path in which the attack path consideration priority is less than the tolerance value.

13. The secure system automated design method according to claim 9, further comprising:
deriving the attack path consideration priority by multiplying the threat consideration priority derived for all of the threats constituting the attack path; and
setting the threat consideration priority of the threats for which a countermeasure has been derived to a value lower than an attack path threshold.

14. The secure system automated design method according to claim 10, further comprising:
deriving the attack path consideration priority by multiplying the threat consideration priority derived for all of the threats constituting the attack path, and a threat concretization relationship consideration priority derived for the relationships between all of the threats constituting the attack path; and
setting the threat consideration priority of the threats for which a countermeasure has been derived to a value lower than an attack path threshold.

15. A non-transitory storage medium storing a program that causes a computer to execute:
accepting a design requirement of a system;
generating a system configuration plan that satisfies the design requirement;
deriving threats that are present in the system configuration plan, attack paths that are constituted by a chain of the threats, and countermeasures that are implemented with respect to the threats; and
deriving a threat consideration priority that represents a priority with which the threats are to be considered, and an attack path consideration priority that represents a priority with which the attack paths are to be considered.
